(19) United States
(12) Patent Application Publication
(10) Pub. No.: US 2012/0171269 A1
(43) Pub. Date: Jul. 5, 2012

(54) Anti-microbial articles for land vehicles, aircraft and marine craft, and method of manufacturing and using same

(76) Inventor: Michael T. Kostak, Mountain Lakes, NJ (US)

(21) Appl. No.: 12/930,124

(22) Filed: Dec. 29, 2010

(51) Int. Cl. A01N 25/08; A01P 1/00; A01N 59/16; B82Y 30/00

(52) U.S. Cl. 424/409; 424/618; 977/810; 977/773

(57) ABSTRACT

Nanoparticles such as nanosilver or nanocopper are used for the construct of anti-microbial articles and accessories for vehicles, trains, and/or airplanes. The anti-microbial articles include a distal section, proximal section and a primary section. The primary section further comprises nanosilver or nanocopper. In one embodiment the nanoparticles comprise a plurality of nanosilver fibers braided, woven or otherwise interwoven to form at least a portion of the primary section. Alternatively, the nanosilver is comprised of a coating over the primary section. The entire article may include the nanosilver composite. The anti-microbial article for vehicles, train, and/or airplanes includes steering wheels, steering wheel covers, gear shifts, gear shift covers, head rests, head rest covers, seats, seat covers, infant seats, infant seat covers, rugs or mats, neck pillows, door handles, door handle covers and travel blankets. Advantageously, the antimicrobial article provides a sanitary environment that kills bacteria and retards bacteria growth.

### BACKGROUND OF THE INVENTION

1. Field of the Invention

The present invention relates to anti-microbial articles, improved articles, and method of using nanoparticles such as nanosilver or nanocopper particles, in the construct of accessories and articles for vehicles (land vehicles, water vehicles, etc.), trains, and/or airplanes; particularly, the article/improved articles for vehicles and airplane is constructed having a distal section, proximal section and a primary section comprising nanosilver particles thereon to impart antimicrobial properties to the articles. The articles include steering wheel covers, shift covers, seat covers, seat head rest covers, neck pillows and travel blankets.

2. Description of the Prior Art

For some time scientists have considered bacteria to be simple, independent, free-floating, single-cell living organisms. However, over the past decade scientists have found that bacteria in natural environments have the ability to participate in a rudimentary form of communication and often live in highly organized communities called biofilms. Biofilms have been found to behave in a different way from free-floating bacteria or bacteria in the planktonic state. Abilities of biofilms include adherence to privileged sited, building protective structures, and communication by chemical signals allowing them to take advantage of strength of numbers and coordinated actions against natural defenses of the host organism. Elimination of the biofilm from the surface is difficult once it is established.

Silver has been found to be a valuable antimicrobial in preventing the formation of harmful biofilms. Medical device manufacturers have looked toward silver, particularly ionic silver as an effective antimicrobial substance for surface modification of medical devices and implants. Gibbins et al., “Surface Treatments—The Role of Antimicrobial Silver Nanotechnology”, Medical Device & Diagnostic Industry, August 2005. A number of reasons for the success of silver in medical devices have been found to include: broad-spectrum antimicrobial action, tissue tolerance, compatibility with material used in making medical devices, ability to be compounded into a submatrix or applied to a surface, and low resistance complications. Id. Deposit of either metallic silver or an ionic salt of silver as a surface-application to the medical device surface is generally utilized. When in the presence of moisture, both forms are activated. However, it has been found that ionic salts have some limitations because they are only active for a short time, such as for only a few days. On the other hand, metallic silver nano-particles have been found to be more advantageous because they continue to deliver antimicrobial silver for as long as 100-200 days. Id. Various products for use in the medical device field utilizing silver as an antimicrobial for external or internal applications in humans and/or animals has been found to prevent bacterial, viral, fungal or other undesirable infections. Products include medical devices, surgical gloves and implements, catheters, implants and other medical implements. These devices can be treated with silver as an antimicrobial agent. Methods of preparing infection-resistant medical devices and antimicrobial medical devices have been proposed in U.S. Pat. Nos. 4,476,590; 5,662,913; 5,849,311; 6,238,686; 6,939,568; 6,989,157; and U.S. Pat. App. Pub. No. 2005/0147657. Other methods and devices concerning the use of silver in medical devices include: Gibbins et al., “Surface Treatments—The Role of Antimicrobial Silver Nanotechnology”, Medical Device & Diagnostic Industry, August 2005; J Agric. Food Chem., Vol. 54, No. 16, pp. 5814-22, PubMed, Accession No. 16881682; and “Nanosilver fights infections” found at URL: www.physorg.com. However, such methods and devices are appointed to be used in an area of the body and many provide this resistance over a period of time while leaching antimicrobial materials into the environment. There remains a need in the art for antimicrobial vehicular accessories utilizing nanosilver technology.

Methods of preparing metallic silver nano-particles and anti-microbial powder coatings have been proposed in U.S. Pat. Nos. 5,851,452 and 7,288,264, and in U.S. Pat. App. Pub. Nos. 2002/0051823; 2004/0156918; 2004/0180098; 2005/0152992; and 2007/0027232. Nanosilver and silver coating and infusing technologies have also been proposed in foreign publications. Example include DE 10253126; JP 2005-126348; JP 2005-334137; JP 2006-009008; JP2007-153645; KR 2004-0110394; MXPA03006280; TW244522 and TW250969. These methods provide for the preparation of the metallic silver nano-particles and substrates, but do not provide anti-microbial silver nano-particles integrated in accessories and articles for vehicles and airplanes to protect consumers from bacteria, disease and infection in their everyday lives.

Nanosilver-absorbed fiber used for raw chemical materials, such as polyester, nylon, and acryl have been proposed. For example, U.S. Pat. App. Pub. No. 2006/0278534 discloses a method for producing nanosilver on a large scale. The nanosilver is produced on large scale by “controlling a minutely electronic current between the two Ag electrodes in water electrolysis system, while a voltage of 10,000-300,000 is applied to two Ag electrodes”. Nanosilver-absorbed fiber is intensively absorbed on the surface of synthetic fibers. The synthetic fibers used are made from raw chemical materials, such as polyester, nylon, and acryl. The absorption of the nanosilver allows the synthetic fibers to obtain good antibacterial activity, “prevent poor perspiration functionality, and the generation of static electricity”. Another example can be found in U.S. Pat. App. Pub. No. 2003/0190851 which discloses an antimicrobial yarn having nanosilver particles. The antimicrobial yarn contains nanosilver particles in the diameter of approximately 1-100 nm. The nanosilver particles are adhered to the fibers of the yarn, consisting of “cotton, linen, silk, wool, blending fabric, or synthetic fiber or any combination that can be used as materials for the yarn”. The antimicrobial yarn is taught to be suitable for use in medical or healthcare related purposes, such as a bandage, gauge, or surgery cloth. A further example can be found at “Nano Silver (Silver™) found at http://www.nanocomposite.net. The Nano Silver publication discuses bonding silver to silica. These methods provide for production of nanosilver raw materials via nanosilver-absorbed fiber and yarns, but do not provide vehicular and airplane accessories having nanosilver integrated therein.

Various consumer products utilizing nanosilver technology have been proposed concerning food storage products, beauty products such as cosmetics, cleansing soap, shampoo, conditioner, body cleanser, dental care, disinfectant spray and pet spray shampoo and conditioner. Such consumer products have been provided by “Nano Silver Wholesale, Ltd.” found at URL: www.nanosilverwholesale.com, and “Silver Nano, Nano Silver” found at URL: www.bluemoongoods.com. However, these consumer products do not disclose vehicular and airplane accessories having nanosilver integrated therein.

There remains a need in the art for anti-microbial articles, improved articles, and methods of using nanosilver for the construct of accessories and articles for vehicles, trains, and/or airplanes to provide an environment conducive to killing bacteria and preventing bacteria growth. Further, there remains a need in the art for anti-microbial article for vehicles, train, and/or airplanes including steering wheel covers, shift covers, head rest covers, seat covers, infant seat covers, rugs or mats, neck pillows, and travel blankets.

### SUMMARY OF THE INVENTION

The present invention discloses an anti-microbial article, improved article, and method of using nanosilver for the construct of accessories and articles for vehicles, trains, and/or airplanes. Applications for which the anti-microbial articles are suited extend to airplanes, trains, water transport vehicles, and the like, in addition to land vehicles.

The anti-microbial article, improved article, and method of using nanosilver involve application of nanosilver technology. Minute nanosilver particles, when incorporated in the constructs of various articles, provide antimicrobial properties to the articles and protect people from bacterial infection. These articles are produced by a process which broadly comprises: (a) combining nanosilver particles with an organic or inorganic material, such as synthetic resin, plastic, ceramic, and/or fibers to form a nanosilver composite; (b) incorporating the nanosilver composite into an article by means of coating/or infusion into the matrix of a substrate material/or other molding, extrusion, weaving, spinning or other process for manufacturing industrial supplies, consumer supplies, and special use goods.

An anti-microbial article for vehicles, trains, and/or airplanes is provided. The anti-microbial article includes a distal section, proximal section and a primary section. The primary section further comprises nanosilver. In one embodiment the nanosilver is comprised of a plurality of nanosilver fibers braided, woven or otherwise interwoven to form at least a portion of the primary section. Alternatively, the nanosilver is comprised of a coating over the primary section. The entire article may include the nanosilver composite. The anti-microbial article for vehicles, train, and/or airplanes includes steering wheel covers, shift covers, head rest covers, seat covers, infant seat covers, rugs or mats, neck pillows, and travel blankets. Advantageously, the antimicrobial article provides a sanitary environment that kills bacteria and retards bacteria growth.

An improved article for vehicles, trains, and/or airplanes, is also provided. The improved article includes a distal section, proximal section and a primary section. The primary section further comprises nanosilver. Wherein the nanosilver provides anti-microbial properties to the article and the primary section is appointed to come into contact with a user. Improved articles include steering wheels, steering wheel covers, gear shifts and shift covers, head rests and head rest covers, seats and seat covers, infant seats and seat covers, covers for shopping carts, high chairs, vehicle infant seats, seat cushions, rugs or mats, neck pillows, and travel blankets. These articles provide enhanced protection to users by killing bacteria and fungi, providing disinfecting properties, and affording a deodorizing affect.

A method of using nanosilver in making an anti-microbial article for vehicles, trains, and/or airplanes, is also provided. A first step of the method comprises forming an article having a distal section, proximal section and a primary section. The second steps calls for coating or impregnating the primary section with nanosilver particles.

### BRIEF DESCRIPTION OF THE DRAWING

The invention will be more fully understood and further advantages will become apparent when reference is had to the following detailed description of the preferred embodiments of the invention and the accompanying drawings, in which:

FIG. 1 is an illustration regarding the structure of nanosilver;

FIG. 2 is a top view of an embodiment of the anti-microbial article for a vehicle wherein the article is a steering wheel cover;

FIG. 3 is a top view of another embodiment of the anti-microbial article for a vehicle wherein the article is a steering wheel cover;

FIG. 4a is a top view of an embodiment of the anti-microbial article for a vehicle wherein the article is a stick shift/shift cover and the cover is placed over a vehicle's shift;

FIG. 4b is a top view of the stick shift/shift cover shown removed from the vehicle's shift;

FIG. 5 is a view of an embodiment of the anti-microbial article for a vehicle wherein the article is a shift/shift cover as located on a steering wheel column or the like (not shown);

FIG. 6 is a view of an embodiment of the anti-microbial article for a vehicle wherein the article is a head rest cover for a vehicle seat (or train/or airplane seat);

FIG. 7 is a view of an embodiment of the anti-microbial article for a vehicle wherein the article is a seat cover for a vehicle seat (or boat, train/or airplane seat);

FIG. 8a is a view of an embodiment of the anti-microbial article for a vehicle wherein the article is a seat cover for an infant's seat, showing the head rest portion detached from a body portion;

FIG. 8b is a view of the anti-microbial infant seat cover of FIG. 8a, showing the head rest portion attached to the body portion;

FIG. 9 is a view of an embodiment of the anti-microbial article for a vehicle wherein the article is a rug or mat for a vehicle, train and/or airplane;

FIG. 10 is a view of an embodiment of the anti-microbial article for a train, vehicle or airplane wherein the article is a neck pillow;

FIG. 11 is a view of an embodiment of the anti-microbial article for a train, vehicle or airplane wherein the article is a travel blanket;

FIG. 12a is a view of an embodiment of the anti-microbial article for a vehicle, such as a shopping cart or seat or chair cover for an infant wherein the article is a seat cover;

FIG. 12b is a view of the seat cover of FIG. 12a as applied on a shopping cart vehicle; and

FIG. 13 is a view of an embodiment of the anti-microbial article for a vehicle, train or airplane wherein the article is a car seat cover.

### DETAILED DESCRIPTION OF THE INVENTION

This invention relates to anti-microbial articles for vehicles (water transport vehicles, and the like, in addition to land vehicles), trains, and/or airplanes. Nanosilver has been found to have excellent conductivity and anti-microbial properties, while being non-harmful to the human body. Nanosilver is formed as a group of micro-sized (nano) bits of silver that are either covering or suspended in a surface. Various methods have been provided for yielding nanosilver coatings, fibers, yarns and textiles as disused hereinabove. The anti-microbial articles for vehicles, train, and/or airplanes of the subject invention incorporate nanosilver particles into substrates and fabric, thereby affording beneficial antimicrobial action during everyday use.

The anti-microbial article, improved article, and method of using nanosilver involve application of nanosilver technology. Minute nanosilver particles, when incorporated in the constructs of various articles, provide antimicrobial properties to the articles and protect people from bacterial infection. These articles are produced by a process which broadly comprises: (a) combining nanosilver particles with an organic or inorganic material, such as synthetic resin, plastic, ceramic, and/or fibers to form a nanosilver composite; (b) incorporating the nanosilver composite into an article by means of coating/or infusion into the matrix of a substrate material/or other molding, extrusion, weaving, spinning or other process for manufacturing industrial supplies, consumer supplies, and special use goods. The particle size of the nanosilver is preferably from 1 to 10 nm. Optionally, the articles are produced by a process wherein copper particles preferably having a size ranging from about 1 to 10 nm are used in place of or together with the nanosilver particles in process steps (a) and (b) above.

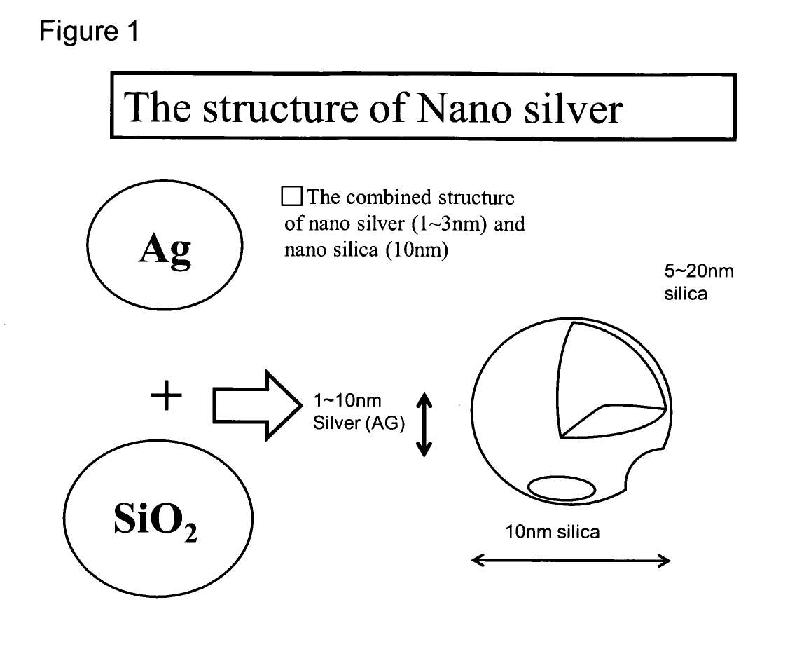

The structure of nanosilver is illustrated in FIG. 1. Metallic silver nano-particles are dispersed in silicon or the like for coating on surfaces, including polymeric, metal, fiber, yarn, nylon, etc. to provide nanosilver raw materials. These nanosilver raw materials are then utilized to construct the anti-microbial articles for vehicles, train, and/or airplanes, including steering wheel covers, shift covers, seat covers, seat head rest covers, neck pillows and travel blankets. U.S. Patent Application Publication Nos. 2006/0278534 and 2003/0190851 disclose methods for producing nanosilver fibers, yarns, and synthetic fibers. The nanosilver particles are adhered to the fibers or yarn, consisting of cotton, linen, silk, wool, blending fabric, or synthetic fiber or any combination that can be used as materials for the yarn.

Nanosilver fibers, yarns and polymeric surfaces are then braided, woven, stitched and/or arranged via heat adhesive to form the antimicrobial vehicle accessories. This improved application of nanosilver technology provides the ability to prevent biofilms and other bacteria from forming in vehicle areas frequently touched, including steering wheels, gear shifts, seats, and head rests. Additionally, particular exposure to harmful biofilms can be encountered by passengers on a train, bus, boat or airplane used for mass transportation. This improved application of nanosilver technology provides the ability to provide a safer travel environment for passengers. Alternatively, the articles can be made from non-nanosilver fibers, yarns and/polymeric or silica materials, and later coated with a nanosilver coating. The nanosilver-adsorbed fiber may be carried out on general cloth types, for example, leather, natural fibers, and synthetic fibers, and preferably with synthetic fibers. The application of the aqueous solution containing the nanosilver to the surface of synthetic fibers is recommended to be carried out using a spraying method, a coating method, or a dipping method followed by coating using a knife or a roll knife. Antibacterial fiber may be utilized. Antibacterial fiber is preferably adsorbed with nanosilver in an amount of 0.01 to 0.1 g per 100 g of synthetic fibers. Adsorption of nanosilver onto the surface of synthetic fibers may be achieved using various processes, including thermal fixation at 150 to 230° C.; high-frequency radiation; and bubbling.

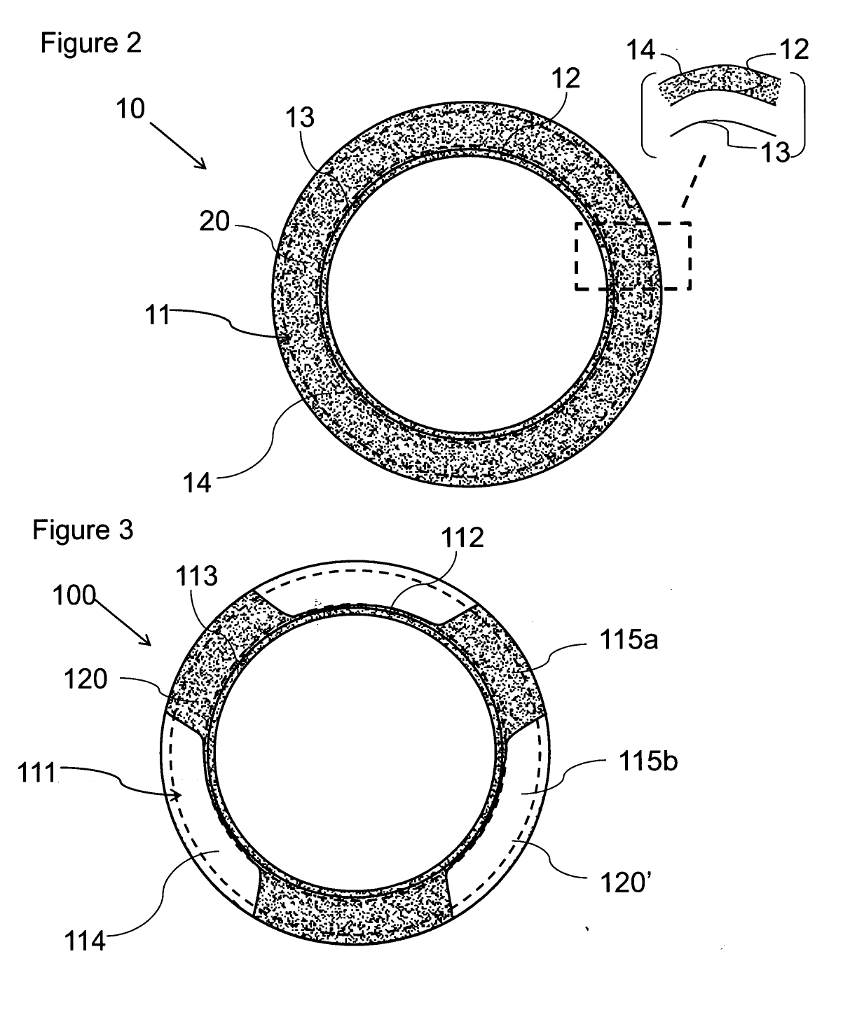

FIGS. 2 and 3 illustrate top views of an embodiment of the anti-microbial article for a vehicle wherein the article is a steering wheel cover, shown generally at 10 and 100, respectively. The anti-microbial article for vehicles, trains, and/or airplanes is constructed as a steering wheel cover 11, 111. The steering wheel cover 11, 111 includes a distal section 12, 112, proximal section 13, 113 and a primary section 14, 114. The primary section 14, 114 further comprises nanosilver 20, 120 integrated therein. In one embodiment the nanosilver 20, 120 is comprised of a plurality of nanosilver fibers braided, woven or otherwise interwoven to form at least a portion of the primary section 14, 114. Alternatively, the nanosilver 20, 120 is comprised of a coating over the primary section 12, 114. The entire article 10, 100 may include the nanosilver composite. Alternatively, either the distal section 12, 112 or proximal section 13, 113 may include the nanosilver 20, 120. The steering wheel cover 11 as shown in FIG. 2 may be entirely comprised of a nanosilver 20 coated fiber that is then interwoven; or of a fiber that is interwoven and later coated with a nanosilver 20 layer. The steering wheel as shown in FIG. 3 may include fibrous sections 115a with nanosilver 120 as well as polymeric sections 115b which may include a nanosilver coating 120′.

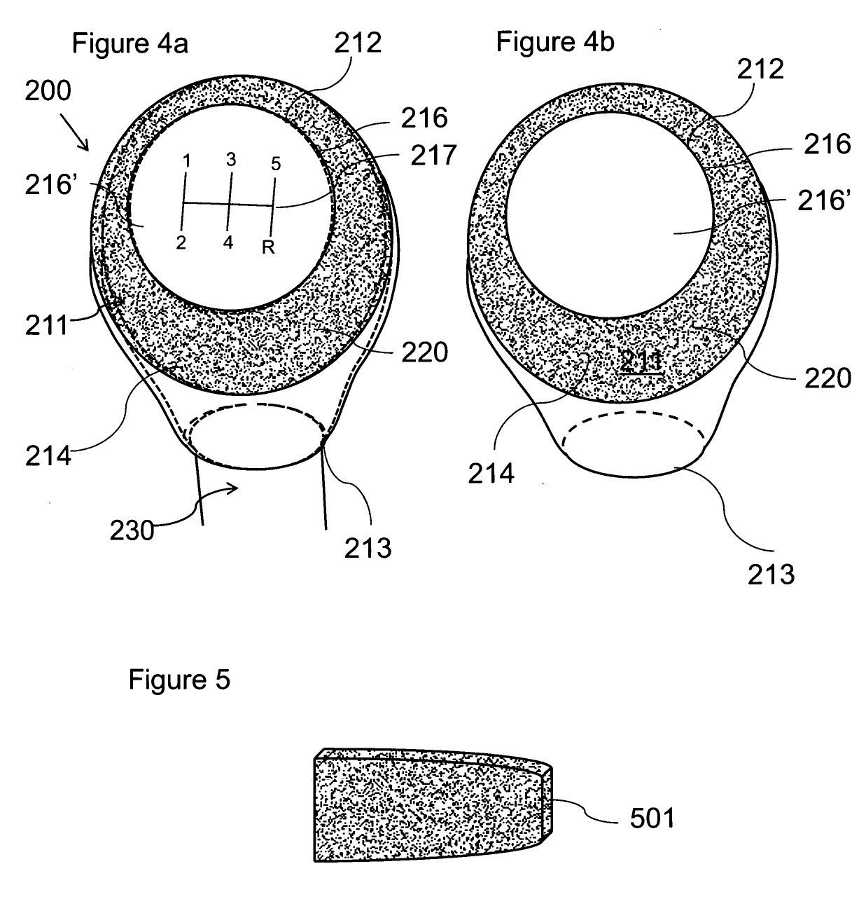

FIGS. 4a and 4b illustrate top views of an embodiment of the anti-microbial article for a vehicle wherein the article is a stick shift/shift cover and the cover is placed over a vehicle's shift, shown generally at 200. The anti-microbial article for vehicles, trains, and/or airplanes is constructed as a stick shift/shift cover 211. The stick shift/shift cover 211 includes a distal section 212, proximal section 213 and a primary section 214. The primary section 214 further comprises nanosilver 220 integrated therein. The distal section 212 may include an aperture 216 that is either a hollow cut-out for the gear shift indicators 217 to appear through. Alternatively, the distal section 212 may comprise a transparent film 216′ which the gear shift indicators 217 are visible through. For gear shifts wherein the gear indicator is not located on the top portion, the aperture 216 will not be needed. The primary section 214 is appointed to come into contact with a user's palm or hand during shifting. The entire article 200 may include the nanosilver 220 composite. The shift cover 211 is composed of an elastic, spandex or nylon material so that it can simply be stretched to fit over the gear shift 230. Shift covers composed of leather are preferably used to cover shift knobs. In such cases cover is sewn onto and forms the exterior surface of the shift knob. Alternatively the shift cover 211 may include a slit in the back-side thereof with hook and loop closures, such as are sold under the trade name VELCRO.

FIG. 5 is a view of an embodiment of the anti-microbial article for a vehicle wherein the article is a shift/shift cover located on a steering wheel column or the like (not shown). Herein the cover simply slides over the shift. The top 501 may include an aperture or cut-out to accommodate any buttons or controls on the top of the column shift.

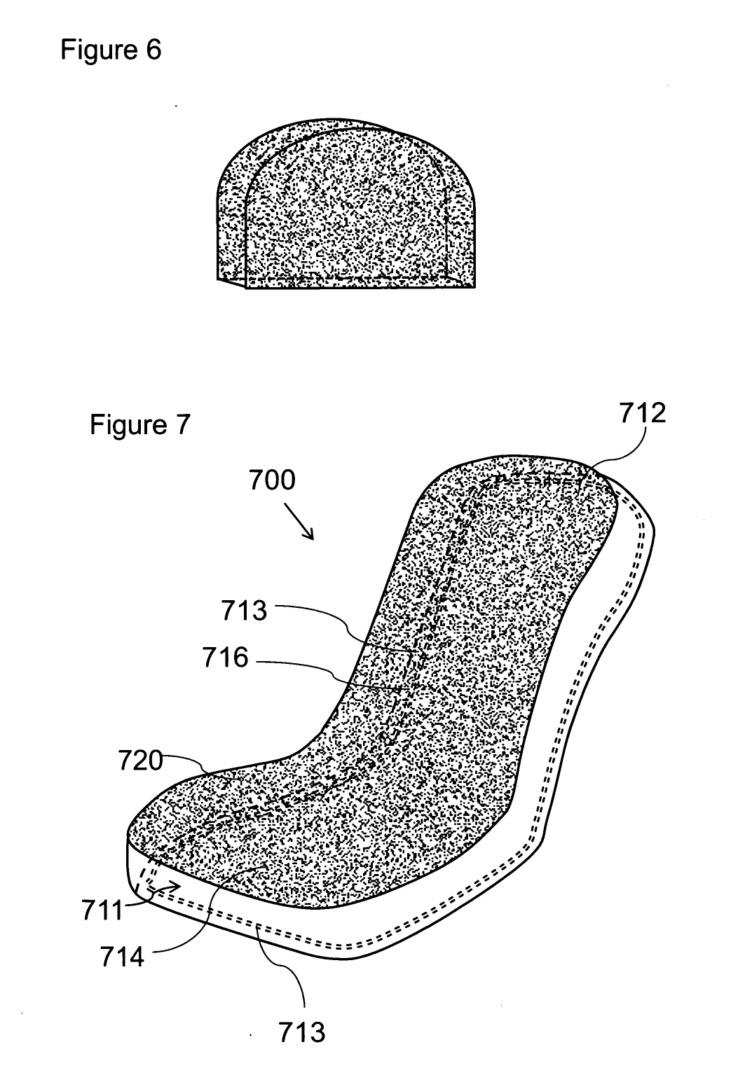

FIG. 6 is a view of an embodiment of the anti-microbial article for a vehicle wherein the article is a head rest cover for a vehicle seat (or train/or airplane seat/water vehicle, and the like). The cover simply slides over a head rest to protect the user's head from bacteria on a head rest or seat.

FIG. 7 is a view of an embodiment of the anti-microbial article for a vehicle wherein the article is a seat cover for a vehicle seat (or train/or airplane seat), shown generally at 700. The anti-microbial article for vehicles, trains, and/or airplanes is constructed as a seat cover 711. The seat cover 711 includes a distal section 712, proximal section 713 and a primary section 714. The primary section 714 further comprises nanosilver 720 integrated therein and is appointed to cover the main seat area—seat area and back area. The seat cover 711 includes an elongated slit 713 that preferably circumferentially runs along the back of the cover 711 for insertion of the vehicle/train/ airplane/or boat seat. The elongated slit 713 preferably includes an elastic rim 714 for providing stability and securement of the cover 711. Draw strings or straps can alternatively be used to provide stability and securement to cover 711.

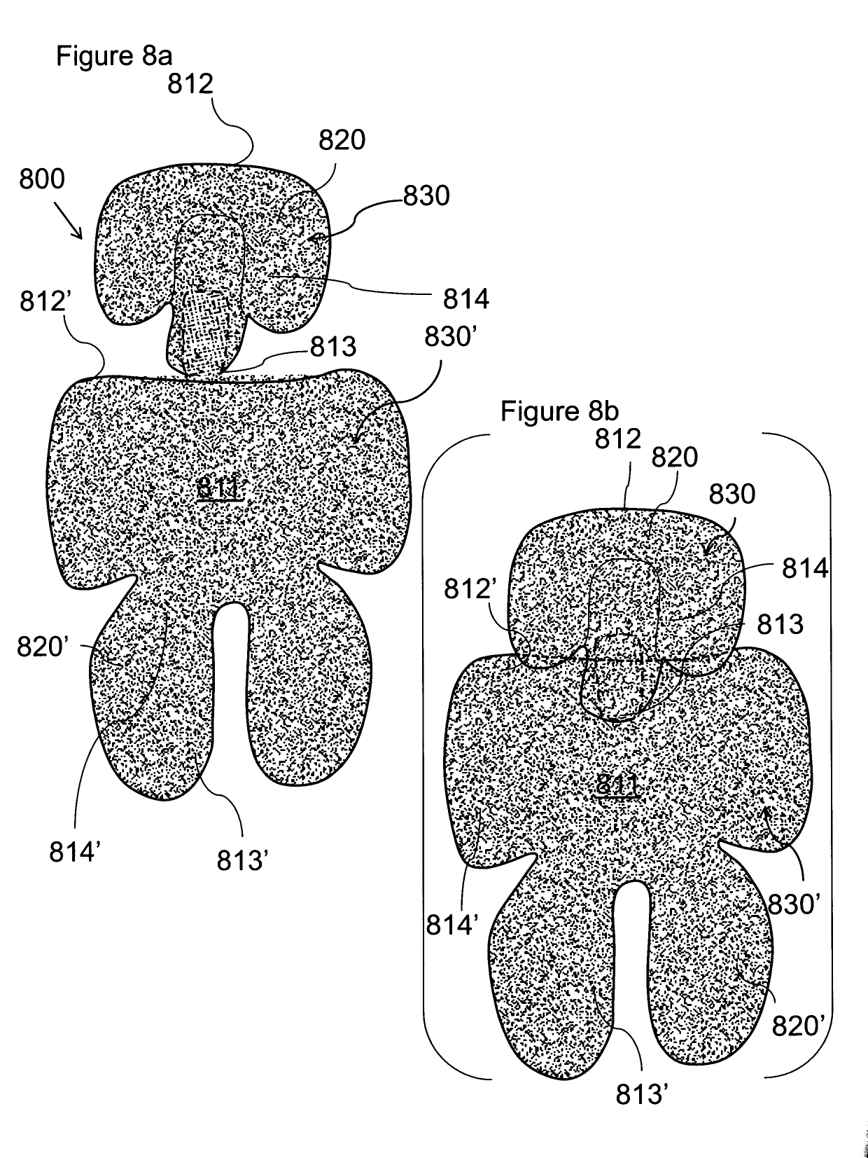

FIGS. 8a and 8b illustrate views of an embodiment of the anti-microbial article for a vehicle wherein the article is a seat cover for an infant's seat, shown generally at 800. The infant seat cover preferably includes a head rest portion shown at 830 and a body portion shown at 830′ that are removably attached to one another, preferably by way of hook and loop closures such as those sold under the trade name VELCRO. The anti-microbial infant seat cover 811 includes a distal section 812, 812′, proximal section 813, 813′ and a primary section 814, 814′. The primary section 814, 814′ further comprises nanosilver 820, 820′ integrated therein, and is appointed to cover the main seat area—seat area and back area.

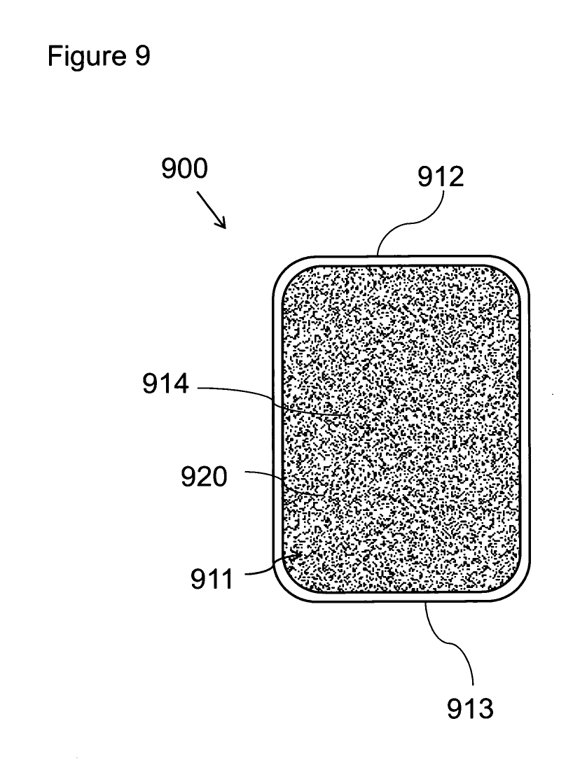

FIG. 9 is a view of an embodiment of the anti-microbial article for a vehicle wherein the article is a rug or mat for a vehicle, train and/or airplane, shown generally at 900. The anti-microbial rug/mat 911 includes a distal section 912, proximal section 913 and a primary section 914. The primary section 914 further comprises nanosilver 920 integrated therein. The rug/mat 911 is appointed to be utilized as vehicle place mats, airplane rugs/mats, boat rugs/mats, and/or train rugs/mats. The size and shape of the mat 911 can be readily modified without departing from the invention.

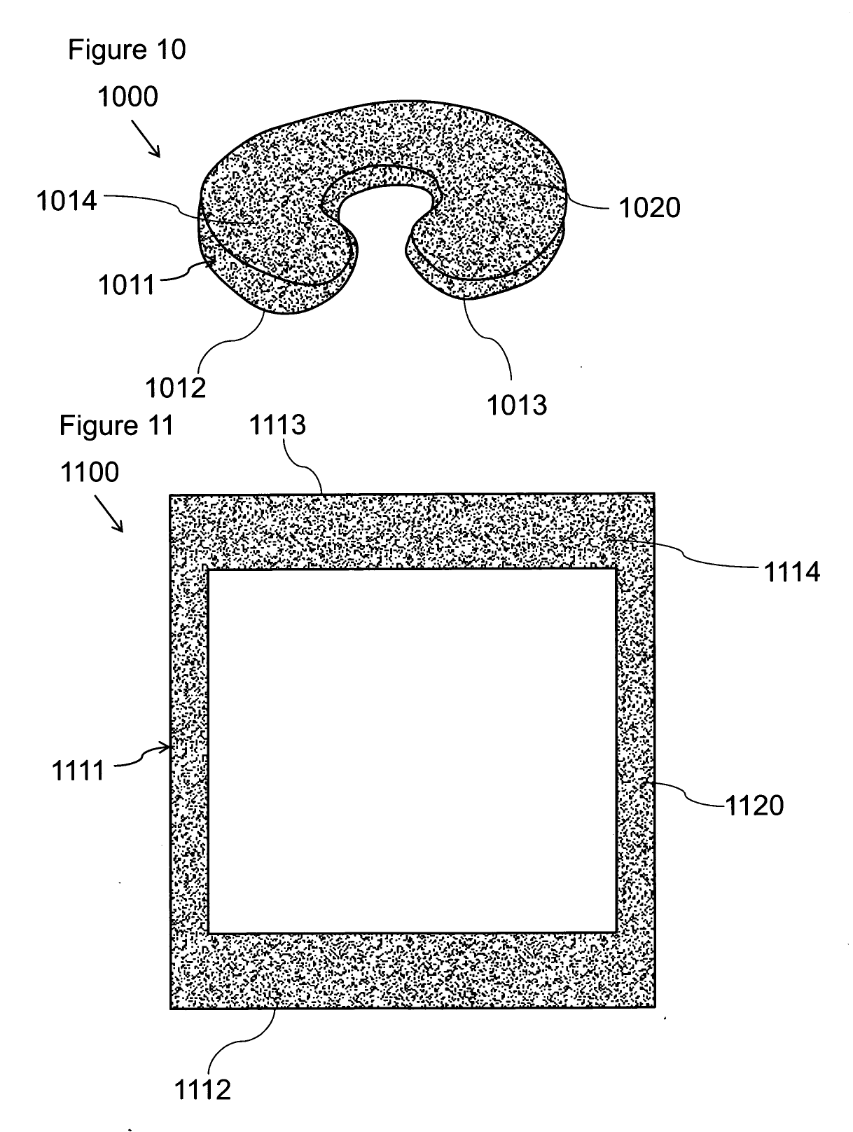

FIG. 10 is a view of an embodiment of the anti-microbial article for a train, vehicle or airplane wherein the article is a neck pillow, shown generally at 1000. The anti-microbial neck pillow 1011 includes a distal section 1012, proximal section 1013 and a primary section 1014. The primary section 1014 further comprises nanosilver 1020 integrated therein. In an alternative embodiment, the exterior of the neck pillow can be removed. The neck pillow 1011 is appointed to be utilized around a user's neck to rest his/her head while traveling. The size and shape of the neck pillow 1011 can be readily modified without departing from the invention.

FIG. 11 is a view of an embodiment of the anti-microbial article for a train, vehicle or airplane wherein the article is a travel blanket or infant changing blanket, shown generally at 1100. The travel blanket 1111 includes a distal section 1112, proximal section 1113 and a primary section 1114. The primary section 1114 further comprises nanosilver 1120 integrated therein. The travel blanket 1111 is appointed to be utilized on a user's body while traveling. The size and shape of the travel blanket 1111 can be readily modified without departing from the invention. The primary section 1114 having the nanosilver 1120 can be modified to reflect the outer rim of the blanket 1111; but preferably the primary section 1114 nanosilver 1120 area covers substantially the entire blanket 1111.

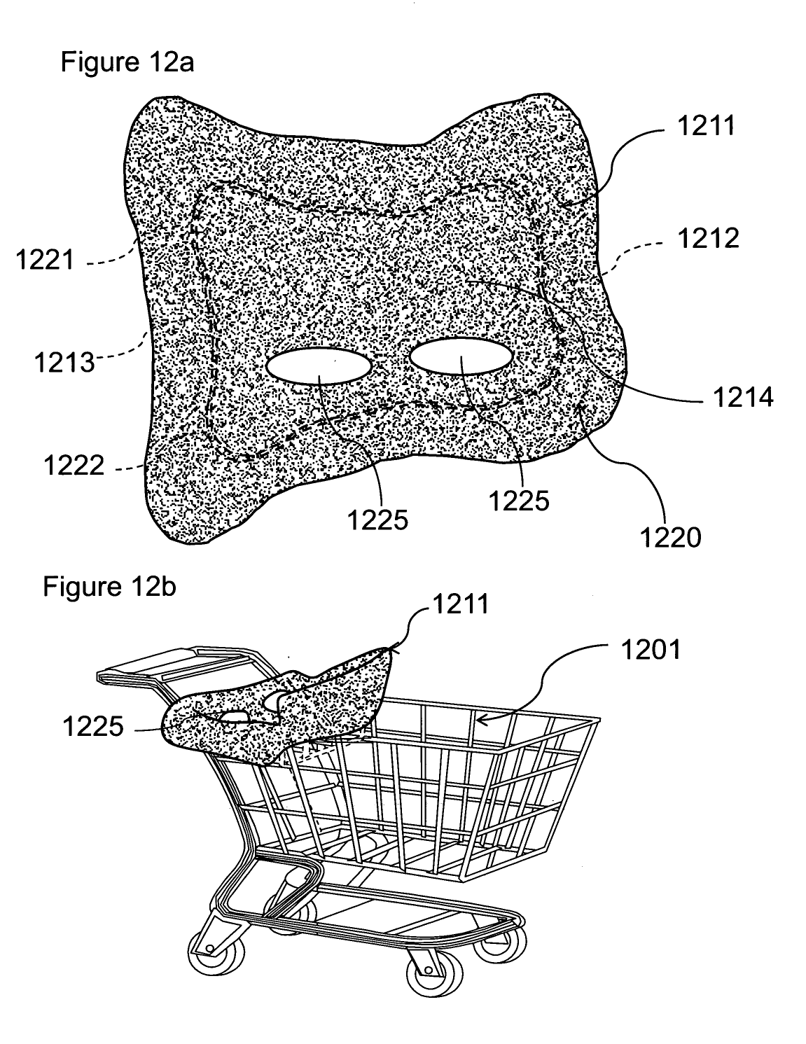

FIGS. 12a and 12b illustrate views of an embodiment of the anti-microbial article for a vehicle, such as a shopping cart wherein the article is a seat cover for protecting an infant from germs. Herein the article is a seat cover 1211 adapted to be placed on a shopping cart 1201, bouncer seat, walker, high chair, etc., to protect an infant from residual germs and bacteria thereon. The seat cover 1211 includes a distal section 1212, proximal section 1213 and a primary section 1214. At least the primary section 1214 further comprises nanosilver 1220 integrated therein. Preferably the primary section 1214 nanosilver 1220 area covers substantially the entire seat cover 1211. The seat cover 1211 includes an elongated slit 1221 located on rim 1222 circumferential to the distal and proximal sections 1212, 1213. The rim 1222 may include a securing means, such as an elastic band. Leg apertures 1225 are provided to allow an infant's legs to pass through when the infant is seated in the seat cover 1211.

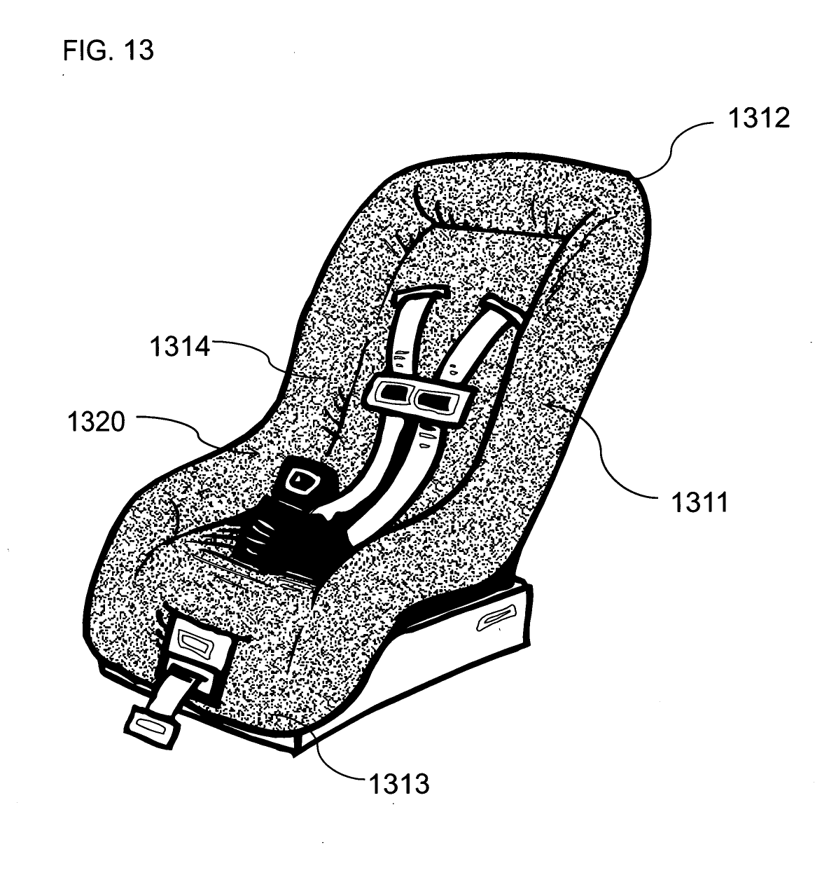

FIG. 13 is a view of an embodiment of the anti-microbial article for a vehicle, train or airplane wherein the article is a car seat cover 1311. The car seat cover 1311 includes a distal section 1312, proximal section 1313 and a primary section 1314. At least the primary section 1314 further comprises nanosilver 1320 integrated therein. Preferably the primary section 1314 nanosilver 1320 area covers substantially the entire car seat cover 1311.

In another embodiment of the anti-microbial article for a train, vehicle or airplane is an air freshener or deodorizer, the air freshener or deodorizer is constructed of fibrous material and formed into a plethora of shapes. A string attached to the deodorizer enables it to hang from an object, such as a mirror, in the vehicle, train, airplane, or the like, to eliminate odors. The anti-microbial article and method of using nanosilver disclosed herein can be modified in numerous ways without departing from the scope of the invention. Optional nano technology can be utilized such as, for example, technology wherein copper particles are utilized instead of nanosilver to impart the anti-microbial properties to the articles. The anti-microbial article, improved article, and method of using nanosilver disclosed herein can be modified and constructed to form non-vehicle related articles, such as baby seat covers, door handles or door handle covers, covers for shopping cart seats and handles, child safety seats, covers for child safety seats (whether used inside or outside of a vehicle), travel blankets, changing blankets for children, pet beds and pet carriers, and other consumer products.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1. An anti-microbial article for vehicles, trains, boats and/or airplanes, comprising:
a. a distal section, proximal section and a primary section;
b. said primary section further comprising nanosilver.

2. An anti-microbial article for vehicles, trains, boats and/or airplanes as recited by claim 1, wherein said nanosilver is comprised of a plurality of nanosilver fibers.

3. An anti-microbial article for vehicles, trains, boats and/or airplanes as recited by claim 1, wherein said nanosilver is comprised of a coating of nanosilver over said primary section.

4. An anti-microbial article for vehicles, trains, boats and/or airplanes as recited by claim 1, wherein said distal section includes said nanosilver fibers.

5. An anti-microbial article for vehicles, trains, boats and/or airplanes as recited by claim 1, wherein said proximal section includes said nanosilver fibers.

6. An anti-microbial article for vehicles, trains, boats and/or airplanes as recited by claim 1, wherein said article is a steering wheel cover.

7. An anti-microbial article for vehicles, trains, boats and/or airplanes as recited by claim 1, wherein said article is a shift cover.

8. An anti-microbial article for vehicles, trains, boats and/or airplanes as recited by claim 1, wherein said article is a head rest cover.

9. An anti-microbial article for vehicles, trains, boats and/or airplanes as recited by claim 1, wherein said article is a seat cover.

10. An anti-microbial article for vehicles, trains, boats and/or airplanes as recited by claim 1, wherein said article is an infant's safety seat or infant seat cover.

11. An anti-microbial article for vehicles, trains, boats and/or airplanes as recited by claim 1, wherein said article is a rug or mat.

12. An anti-microbial article for vehicles, trains, boats and/or airplanes as recited by claim 1, wherein said article is a neck pillow.

13. An anti-microbial article for vehicles, trains, boats and/or airplanes as recited by claim 1, wherein said article is a travel blanket.

14. An improved article for vehicles, trains, boats and/or airplanes, comprising:
a. a distal section, proximal section and a primary section;
b. said primary section further comprising nanosilver, wherein said nanosilver provides anti-microbial properties to said article and said primary section is appointed to come into contact with a user.

15. An anti-microbial article for vehicles, trains, boats and/or airplanes as recited by claim 14, wherein said article is a steering wheel cover.

16. An anti-microbial article for vehicles, trains, boats and/or airplanes as recited by claim 14, wherein said article is a shift cover.

17. An anti-microbial article for vehicles, trains, boats and/or airplanes as recited by claim 14, wherein said article is a head rest cover.

18. An anti-microbial article for vehicles, trains, boats and/or airplanes as recited by claim 14, wherein said article is a seat cover.

19. An anti-microbial article for vehicles, trains, boats and/or airplanes as recited by claim 14, wherein said article is an infant's seat cover.

20. An anti-microbial article for vehicles, trains, boats and/or airplanes as recited by claim 14, wherein said article is a rug or mat.

21. An anti-microbial article for vehicles, trains, boats and/or airplanes as recited by claim 14, wherein said article is a neck pillow.

22. An anti-microbial article for vehicles, trains, boats and/or airplanes as recited by claim 14, wherein said article is a travel blanket.

23. An anti-microbial article for vehicles, trains, boats and/or airplanes as recited by claim 14, wherein said article is an air freshener or deodorizer.

24. An improved non-vehicle related article, comprising:
a. a distal section, proximal section and a primary section;
b. said primary section further comprising nanosilver.

25. An improved non-vehicle related article, as recited by claim 24, wherein said article is selected from the group consisting of highchairs, highchair covers, door handles, door handle covers, covers for shopping cart seats and handles, picnic blankets, changing blankets for children, pet beds and pet carriers.

26. An anti-microbial article for vehicles, trains, boats and/or airplanes, comprising the steps of:
a. forming an article having a distal section, proximal section and a primary section;
b. coating said primary section with nanosilver particles.
